(19) United States
(12) Patent Application Publication
(10) Pub. No.: US 2024/0348908 A1
(43) Pub. Date: Oct. 17, 2024

(54) DOORBELL HOUSING

(71) Applicant: SkyBell Technologies IP, LLC, Irvine, CA (US)

(72) Inventor: Joseph Frank Scalisi, Lakeway, TX (US)

(21) Appl. No.: 18/755,036

(22) Filed: Jun. 26, 2024

Related U.S. Application Data
(63) Continuation-in-part of application No. PCT/US22/81311, filed on Dec. 9, 2022.
(60) Provisional application No. 63/294,577, filed on Dec. 29, 2021.

(51) Int. Cl. H04N 23/57; G06V 40/19; H04N 7/18; H04N 23/51; H04N 23/56; H04R 1/02

(52) U.S. Cl. CPC H04N 23/57; G06V 40/19; H04N 7/186; H04N 23/51; H04N 23/56; H04R 1/028

(57) ABSTRACT

The disclosure includes a doorbell system, comprising a housing having a flat back surface and a curved front surface facing opposite the flat back surface. In some embodiments, the doorbell system comprises a doorbell coupled to the housing, the doorbell including a visitor detection system comprising a detection device selected from the group consisting of a camera, a microphone, and a motion detector.

### CROSS-REFERENCE TO RELATED APPLICATIONS

The entire contents of the following application are incorporated by reference herein: U.S. Provisional Patent Application No. 63/294,577; filed Dec. 29, 2021; and entitled DOORBELL HOUSING.

The entire contents of the following application are incorporated by reference herein: PCT Patent Application No. US22/81311; filed Dec. 9, 2022; and entitled DOORBELL HOUSING.

Various embodiments disclosed herein relate to doorbells. Certain embodiments relate to a shape of a doorbell housing.

Doorbells can enable a person located outside of an entry point, such as a door, to alert a person inside of an entry point that someone outside would like to talk to someone inside. Doorbells sometimes include a button located near a door, such as a front door, side door, or back door of a home, office, dwelling, warehouse, building, or structure. Doorbells are sometimes used near a gate or other entrance to a partially enclosed area. Pushing the doorbell sometimes causes a chime or other alerting sound to be emitted.

### SUMMARY

The disclosure includes a doorbell system, comprising a housing having a flat back surface and a curved front surface facing opposite the flat back surface. In some embodiments, the doorbell system comprises a doorbell coupled to the housing, the doorbell including a visitor detection system comprising a detection device selected from the group consisting of a camera, a microphone, and a motion detector.

According to some embodiments, the curved front surface defines a concave curvature. The degree of curvature of the front surface may be substantially symmetrical about a central horizontal axis of the housing. In some embodiments, the housing defines a substantially ovular circumferential profile. According to some embodiments, the housing includes a first surface and a second surface opposite the first surface. The first surface and the second surface may be substantially parallel for at least a portion of a length of the doorbell.

In some embodiments, the housing includes a top surface and a bottom surface opposite the top surface. According to some embodiments, at least a portion of the top surface and at least a portion of the bottom surface comprise tapered profiles. The tapered profile of the top surface may taper downward from the back surface toward the front surface, and the tapered profile of the bottom surface may taper upward from the back surface toward the front surface.

In some embodiments, the doorbell system further comprises a software application running on a remote computing device communicatively coupled to the doorbell. According to some embodiments, the camera is located above a central horizontal axis of the housing. The camera may point at least partially downward toward a bottom side of the doorbell. In some embodiments, the camera has a vertical field of vision between 140 degrees and 160 degrees. According to some embodiments, the camera further comprises a retinal scanner for identifying a visitor.

The doorbell system may further comprise a printed circuit board coupled to the housing, the printed circuit board electronically coupled to the camera. In some embodiments, the printed circuit board is mechanically coupled to the camera. According to some embodiments, the printed circuit board is arranged and configured to at least partially align with a curvature of the housing. The housing may further comprise a camera aperture and a camera surface adjacent to the camera aperture, the camera aperture configured to provide a viewing window for the camera, wherein the printed circuit board is substantially parallel to the camera surface.

In some embodiments, the doorbell system further comprises a projection light coupled to a bottom surface of the housing, wherein the projection light is configured to project an illumination on a surface. According to some embodiments, the projection light is configured to constantly project the illumination. The projection light may be aimed away from a central horizontal axis and the projection light is aimed along a central vertical axis. In some embodiments, the projection light is coupled to a tapered portion of the bottom surface of the housing, such that the projection light is aimed away from both a central horizontal axis and a central vertical axis. According to some embodiments, the projection light is configured to project the illumination in response to a press of a button. The projection light may be configured to project the illumination in response to an indication of a presence of a visitor by a camera.

In some embodiments, the detection system further comprises a speaker. According to some embodiments, the speaker is located adjacent a top surface of the housing. A curvature of the front surface may be arranged and configured to enhance a sound quality from the speaker. In some embodiments, the sound quality comprises a treble component and a bass component.

### BRIEF DESCRIPTION OF DRAWINGS

These and other features, aspects, and advantages are described below with reference to the drawings, which are intended to illustrate, but not to limit, the invention. In the drawings, like characters denote corresponding features consistently throughout similar embodiments.

FIG. 1 illustrates a front view of a doorbell system coupled to a building, according to some embodiments.

FIG. 2 illustrates a side perspective view of the doorbell, according to some embodiments.

FIG. 3A illustrates a front view of the doorbell, according to some embodiments.

FIG. 3B illustrates a front view of the doorbell, according to some embodiments.

FIG. 4A illustrates a partial front view of the doorbell, according to some embodiments.

FIG. 4B illustrates a partial front view of the doorbell, according to some embodiments.

FIG. 5A illustrates a top view of the doorbell, according to some embodiments.

FIG. 5B illustrates a top view of the doorbell, according to some embodiments.

FIG. 6A illustrates a side view of the doorbell showing hidden lines, according to some embodiments.

FIG. 6B illustrates a side view of the doorbell showing hidden lines, according to some embodiments.

FIG. 7 illustrates a doorbell communicatively coupled to a remote computing device, according to some embodiments.

FIG. 8 illustrates a front view of a doorbell with a portion of the housing removed, according to some embodiments.

FIG. 9 illustrates a side view of the doorbell of FIG. 8, according to some embodiments.

### DETAILED DESCRIPTION OF THE INVENTION

Although certain embodiments and examples are disclosed below, inventive subject matter extends beyond the specifically disclosed embodiments to other alternative embodiments, uses, or both, and modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order-dependent. Additionally, the structures, systems, and devices described herein may embody integrated components or separate components.

For purposes of comparing various embodiments, certain aspects and advantages of these embodiments are described. However, not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Currently, doorbells in the prior art are subject to a flat front surface, causing the doorbell to face directly outward, perpendicular to the surface on which they reside. In the case of smart doorbells, which may contain features meant to see items such as packages beneath the doorbell, this can cause issues.

For instance, if a package were placed directly beneath a doorbell, the doorbell may only be able to see the package should its vertical field of view be 180 degrees. This large vertical field of view may cause a decrease in image quality, which would mean the other intended functions of the doorbell, such as seeing a visitor in front of the doorbell, may suffer.

Current doorbell systems seek to rectify this issue by placing a wedge-type implement between the doorbell and the surface on which the doorbell resides. However, this adds additional, unnecessary costs and components to an implement that is already seeing rising costs due to the additional features doorbells have been gaining. Thus there is a need in the art for a solution to the problem of cameras on doorbells facing directly outward. The solution is described below and creates additional benefits that will also be further discussed.

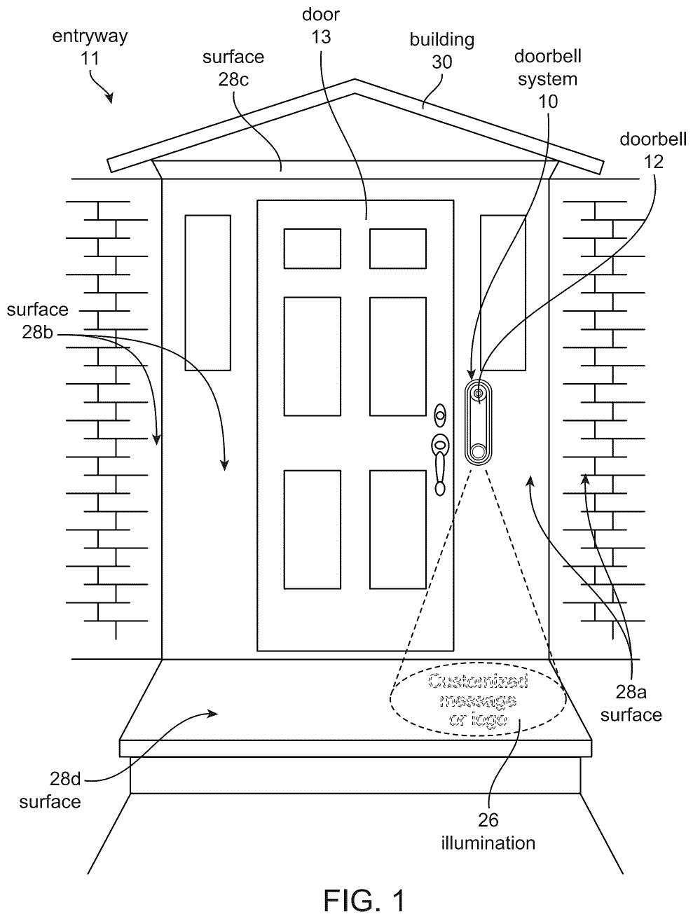

FIG. 1 illustrates a front view of an entryway 11 to building 30, including a door 13 that opens to reveal a walkway inside building 30. FIG. 1 shows a front view of a doorbell system 10, including a doorbell 12 configured to project an illumination 26 onto a surface 28. While not shown in FIG. 1, the doorbell 12 also includes a light 24 configured to project the illumination 26 onto surface 28. The doorbell 12 may be configured to project the illumination 26 onto the surface 28d directly in front of the doorbell 12, to either side on the ground surface 28d in front of the doorbell 12, and any other location viewable by a visitor. In some embodiments, doorbell 12 is configured to project illumination 26 onto any surface adjacent to entryway 11, such as surfaces 28a, 28b, 28c, 28d, and 28c. As shown in FIG. 1, doorbell 12 is attached to the building 30 and located on a side surface 28a of door 13. In some embodiments, the doorbell 12 is attached to any surface 28 on or adjacent the entryway, such as either surface 28a, 28b located on the side of the door 13, surface 28c situated above the door 13, on the door 13 itself, surface 28d situated on the ground in front of the door 13, and any other surface on the building 30.

In some embodiments, the doorbell 12 is configured to constantly (always) project the illumination 26. In some embodiments, the illumination 26 may be projected in response to a trigger, such as the press of a doorbell button 16, detection of sound by a microphone 20 of the visitor detection system 14, detection of motion by a motion detector 22 of the visitor detection system 14, detecting any indication of a presence of a visitor by the doorbell 12, powering on the electronic doorbell, providing power to the electronic doorbell, and the like. The illumination 26 may also be activated in response to a camera 18 of the visitor detection system 14 detecting an indication of a visitor's presence.

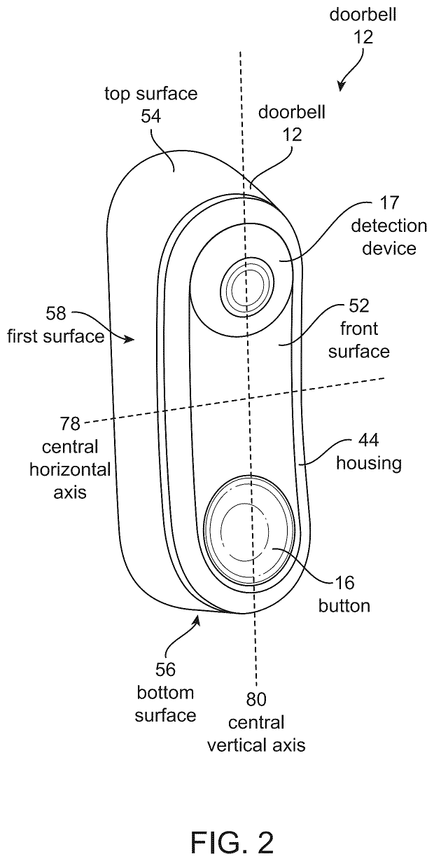

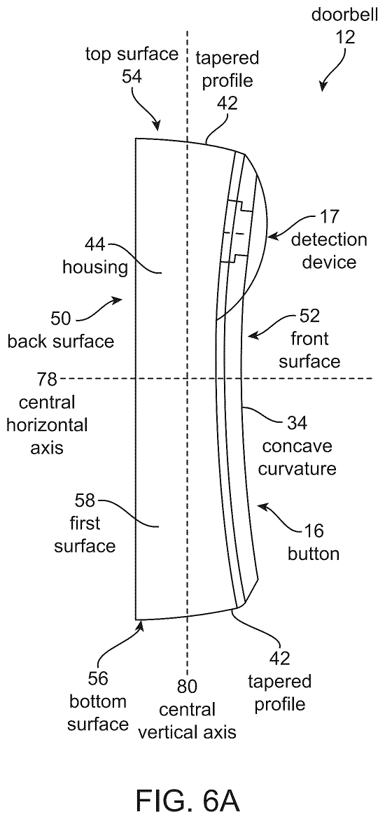

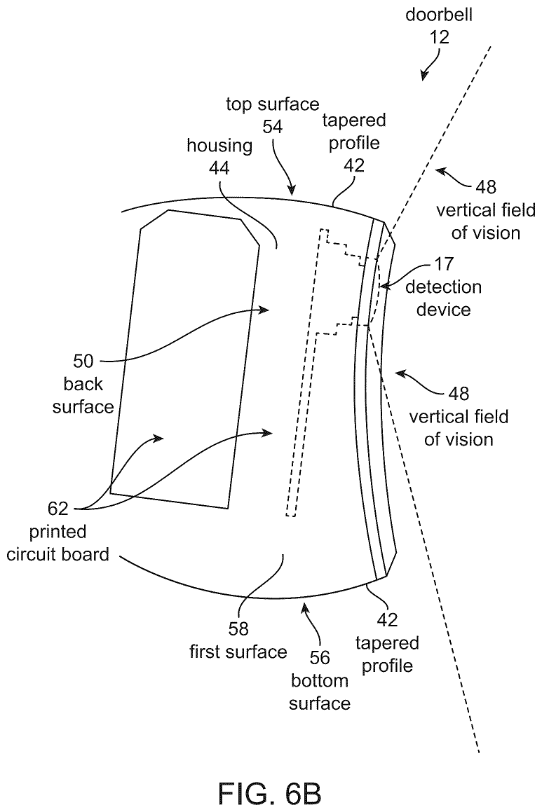

FIG. 2 illustrates a side perspective view of the doorbell system 10, according to some embodiments. In some embodiments, the doorbell system 10 includes a doorbell 12. The doorbell 12 may include a housing 44. In some embodiments, the housing includes a front surface 52, a back surface 50 (not shown), a top surface 54, a bottom surface 56, a first surface 58, and a second surface 60 (not shown). According to some embodiments, including the embodiment illustrated in FIG. 2, the back surface 50 and the front surface 52 are opposite one another. The top surface 54 and the bottom surface 56 may be opposite one another. As will be illustrated in greater detail in FIGS. 6A and 6B, the top surface 54 may taper in a downward direction from the back surface 50 to the front surface 52. The bottom surface 56 may taper in an upward direction from the back surface 50 to the front surface 52.

Also illustrated in FIG. 2 are a central horizontal axis 78 and a central vertical axis 80. While these axes are inherent properties of any two-dimensional or three-dimensional shape, and many features will be discussed with respect to their orientation, any symmetry found about these axes is not an intrinsic property of the doorbell system 10. Additionally, any features that are described as being in a specific location or pointing in a particular direction with respect to the central horizontal axis 78 or the central vertical axis 80 should be construed as exemplary only, and any other locations or direction of pointing is feasible for all features as well.

FIG. 2 also illustrates how the front surface 52 of the housing 44 has a curvature. This curvature is illustrated and discussed further in FIGS. 6A and 6B, where the side view allows for a better perspective of the exemplified curvature.

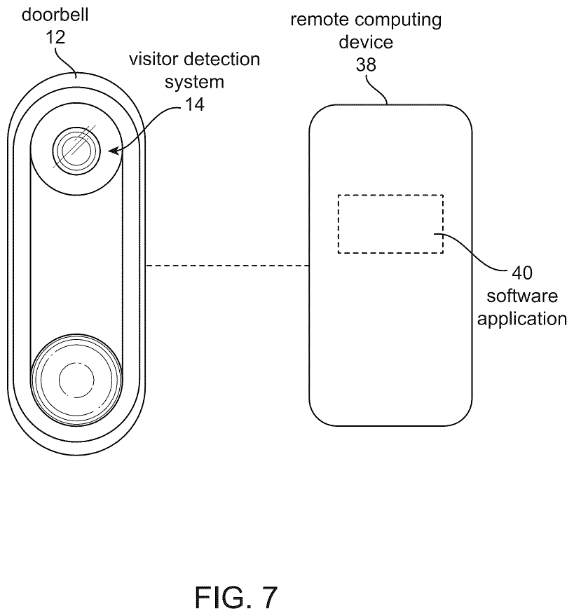

FIG. 2 also shows a button 16, which, in this embodiment, is located approximately centered on the central vertical axis 80 and below the central horizontal axis 78. According to some embodiments, button 16 is coupled to an inside of the front surface 52 of the housing 44. Button 16 may be electronically coupled to the doorbell 12. In some embodiments, this electronic coupling occurs through the mediation of a printed circuit board 62, which will be illustrated in greater detail in FIG. 6B. According to some embodiments, button 16 is communicatively coupled to a software application 40 running on a remote computing device 38. This will be illustrated in greater detail in FIG. 7. The button 16 may be a mechanical button 16, but it could also be a touch button 16, such as one driven by capacitance. According to some embodiments, button 16 comprises a fingerprint scanner for identifying a visitor 76.

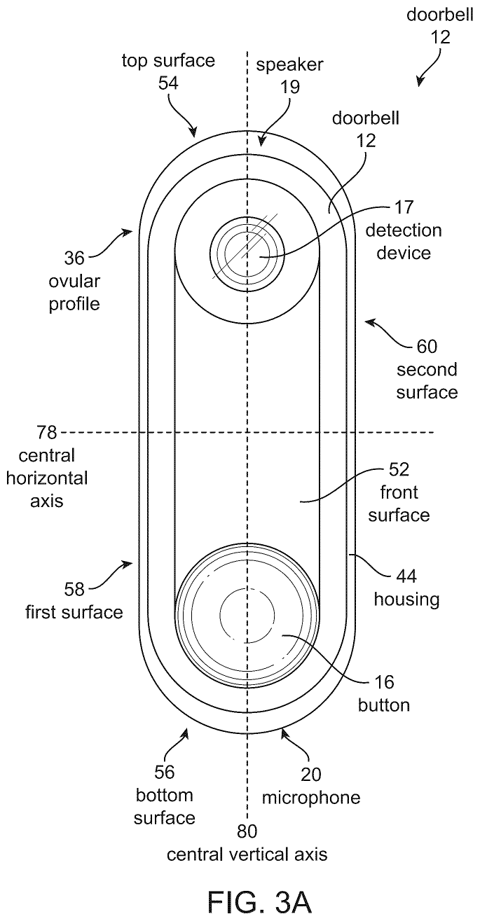

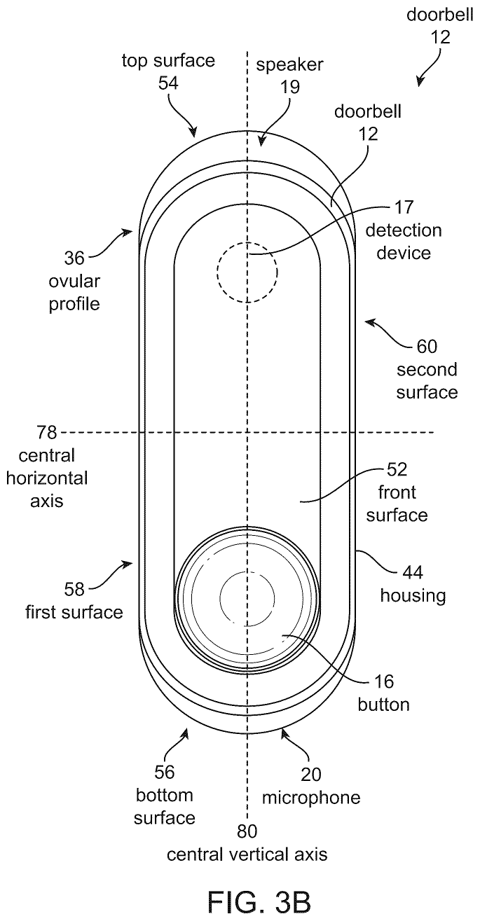

FIGS. 3A and 3B illustrate front views of various embodiments of the doorbell system 10. Both FIGS. 3A and 3B show the generally ovular profile 36 of the doorbell 12. The first surface 58 and the second surface 60 may be on the sides of the doorbell 12 and may be parallel to one another for a length of the doorbell 12. According to some embodiments, the top surface 54 is on the top of the doorbell 12 and the bottom surface 56 is on the bottom of the doorbell 12. Both have a radius of curvature while connecting the first surface 58 to the second surface 60.

Because FIGS. 3A and 3B are front views, the back surface 50 of the doorbell 12 is not shown, and the front surface 52 of the doorbell 12 is fully shown. In some embodiments, including those shown in FIGS. 3A and 3B, button 16 is present, approximately centered on the central vertical axis 80 and below the central horizontal axis 78. However, dissimilar to the embodiment displayed by FIG. 2, there is a detection device 17 present above the central horizontal axis 78 and approximately centered on the central vertical axis 80. Because of the curvature of the front surface 52 of the housing 44, the placement of the button 16 and the detection device 17 are not pointed straight outward, which creates benefits that will be discussed further in FIGS. 6A and 6B.

Also present in the embodiments illustrated by FIGS. 3A and 3B are a speaker 19 and a microphone 20. According to some embodiments, speaker 19 is located on the top surface 54 of the doorbell 12. Speaker 19 may be approximately centered on the central vertical axis 80 but is not limited to this configuration. In some embodiments, microphone 20 is located on the bottom surface 56 of the doorbell 12. According to some embodiments, microphone 20 is approximately centered on the central vertical axis 80 but, as with speaker 19, is not limited to this configuration.

Speaker 19 may be mechanically coupled to the housing 44. According to some embodiments, speaker 19 is electronically coupled to the doorbell 12 and is configured to send sound from the doorbell system 10 to a visitor 76. In some embodiments, the curvature of the front surface 52 is arranged and configured to enhance a sound quality 70 from the speaker 19. This sound quality 70 may be made up of a treble component 72 and a bass component 74, though additional components, such as the amplitude or frequency of the sound waves, may be influenced by the shape of the housing 44.

In some embodiments, the microphone 20 is mechanically coupled to the housing 44. According to some embodiments, the microphone 20 is electronically coupled to the doorbell 12. The doorbell system 10 may be configured to send sounds detected by the microphone 20 to the software application 40 running on the remote computing device 38. The doorbell system 10 may be configured to project the illumination 26 from the projection light 24 in response to any detection of sound by the microphone 20.

While other configurations are possible, embodiments where the speaker 19 is on the top surface 54 and the microphone 20 is on the bottom surface 56 allow for a cleaner duplex capability.

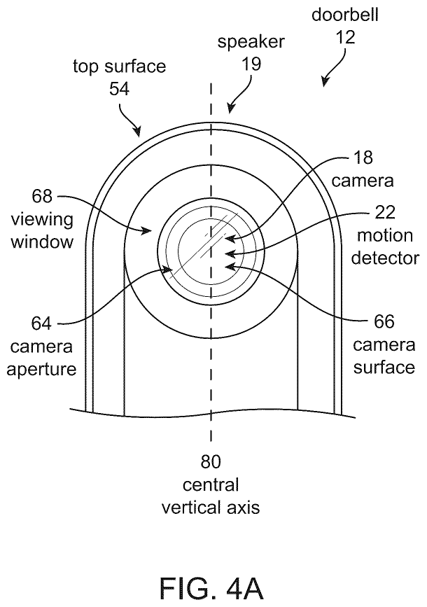

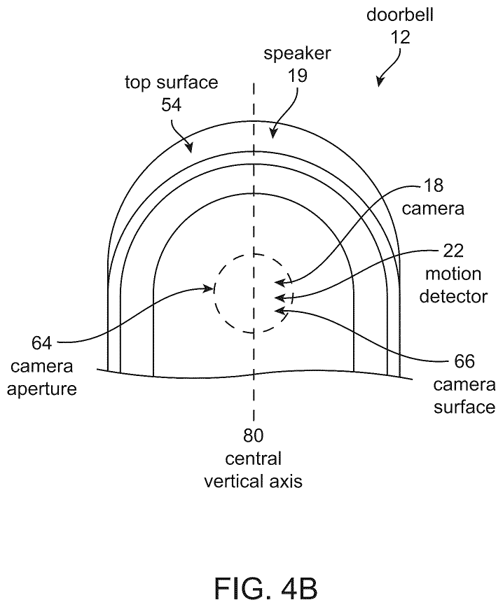

The main difference in the embodiments shown by FIGS. 3A and 3B is seen in the form of the detection device 17. This difference is explored more thoroughly in FIGS. 4A and 4B.

As embodied in both FIGS. 3A and 3B, the overall length of the doorbell 12 (or height, as in this perspective) may be 100 mm. According to some embodiments, the button may have a diameter of 20 mm, as in FIG. 3A, a diameter of 22 mm, as in

FIG. 3B, or any diameter as desired, and as fits on the front surface 52 of the housing 44.

FIGS. 4A and 4B illustrate a partial front view of the doorbell 12, with an emphasis on the location where the detection device 17 is present, according to some embodiments. Both FIGS. 4A and 4B illustrate the detection device 17 present on the front surface 52 of the housing 44, according to some embodiments. The detection device 17 may be approximately centered on the central vertical axis 80, though this is not strictly necessary. A speaker 19 may be present on the top surface 54 of the housing. The detection device 17 is where a difference may be seen.

Concerning FIG. 4A, a viewing window 68 is present in housing 44. Through this viewing window 68, a camera 18 may be inserted. The camera surface 66 may be exposed to the outside of the doorbell 12, giving freedom of access to outdoor scenery to the camera aperture 64 for high-quality imaging. According to some embodiments, the detection device 17 also includes a motion detector 22.

Concerning FIG. 4B, camera 18 is located behind a transparent or translucent membrane of the front surface 52 of the housing 44. In these embodiments, the camera aperture 64 captures imaging through the front surface 52, thus decreasing the footprint of the front surface 52. In embodiments, as shown in FIG. 4B, the detection device 17 may also include a motion detector 22. Additionally, the detection device 17 may include a retinal scanner 46 for identifying a visitor 76.

In embodiments as illustrated in either FIG. 4A or 4B, the doorbell system 10 may be configured to project the illumination 26 from the projection light 24 in response to any image capturing by the camera 18. According to some embodiments, the doorbell system 10 is configured to project illumination 26 from the projection light 24 in response to any motion detected by the motion detector 22.

In some embodiments, including those illustrated by FIG. 4A, the viewing window 68 may have a radius of 12 mm, and the camera aperture 64 may have a radius of 5 mm. In embodiments with a viewing window 68, the viewing window 68 may be as large or small as desired and as fits on the front surface 52 of the housing 44. The camera aperture 64 may also be as large or small as desired, so long as the camera 18 that contains the camera aperture 64 fits through the viewing window 68.

According to some embodiments, such as those illustrated by FIG. 4B, no viewing window 68 is present. Thus the camera aperture 64 may be as large or small as desired, so long as the camera 18 fits within the housing 44 of the doorbell 12.

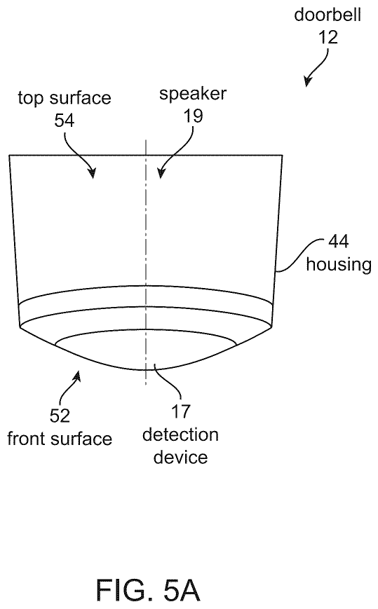

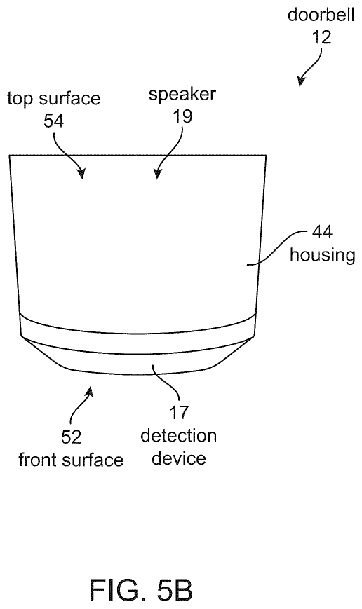

FIGS. 5A and 5B illustrate top views of the doorbell 12, according to some embodiments. These embodiments are the top surface 54 and the front surface 52. A speaker 19 may be present on the top surface 54 of the housing 44. As described in FIGS. 4A and 4B, the footprint of the detection device 17 may be lessened by having camera 18 behind the front surface 52 instead of allowing a viewing window 68 for the camera 18 to be partially inserted through. FIG. 5A shows an embodiment with a viewing window 68, while FIG. 5B illustrates an embodiment without a viewing window 68.

FIGS. 6A and 6B illustrate side views of the doorbell 12, according to some embodiments. FIG. 6A shows a side view as it may be seen by an outside observer, with a few hidden lines displayed to emphasize features, while FIG. 6B illustrates a line view with more detailed hidden lines.

Both FIGS. 6A and 6B show embodiments where the first surface 58 of the housing 44 is facing the viewer. The front surface 52 is displayed with a concave curvature 34. This concave curvature 34 may vary in radius from what is shown in the figures. Additionally, the concavity of the curvature is not strictly necessary, and convex curvatures may be implemented as well. However, the concave curvature 34 may create a profile that allows for extra space in the housing 44 on the top and bottom for storing components, such as electronic components for use and management of the detection device 17, camera 18, or speaker 19.

As shown in FIGS. 6A and 6B, both the top surface 54 and the bottom surface 56 of the housing may be defined by tapered profiles 42. According to some embodiments, the tapered profile 42 of the top surface 54 tapers downward from the back surface 50 toward the front surface 52. In some embodiments, the tapered profile 42 of the bottom surface 56 tapers upward from the back surface 50 toward the front surface 52. While both the top surface 54 and bottom surface 56 tapered profiles 42 share a component number, these tapered profiles 42 do not need to be symmetrical in nature.

FIGS. 6A and 6B (while not labeled in FIG. 6B) show the presence of button 16 beneath the central horizontal axis 78, according to some embodiments. Additionally, FIGS. 6A and 6B illustrate the presence of the detection device 17, according to some embodiments.

FIG. 6A illustrates a central vertical axis 80, as it may be seen from the side of the doorbell 12. While not labeled, the projection light 24 may be located on the bottom surface 56. Because of the tapered profile 42 of the bottom surface 56, the projection light 24 may point away from the central vertical axis 80 instead of straight downward. Additionally, according to some embodiments, the extra space in the bottom of the doorbell 12 caused by the concave curvature 34 of the front surface 52 allows for extra components to be placed for the projection light 24, allowing for improved image quality. According to some embodiments, this concave curvature 34 also creates a larger sound chamber to create a more pronounced sound for the doorbell 12 to improve the user experience.

The detection device 17 may be coupled to an inside of the front surface 52 of the housing 44 above the central horizontal axis 78 such that the detection device 17 may be pointed at least partially downward. According to some embodiments, the doorbell system 10 is configured to send images detected by camera 18 of the detection device 17 to a software application 40 running on a remote computing device 38. Hidden lines in FIG. 6A illustrate where camera 18 may be located.

FIG. 6B illustrates the hidden lines of the printed circuit board 62 as it may be located inside of the doorbell 12, as well as a front view profile of the printed circuit board 62, as seen to the left side of the doorbell. The printed circuit board 62 and the camera 18 may be mechanically coupled, or “chip on board,” which decreases the cost of manufacture and allows for the camera 18 to reside on an angle within the housing 44. The capability for the camera 18 to reside on an angle within the housing 44 may be present due to the printed circuit board 62 lying on a bias with respect to the central horizontal axis 78. According to some embodiments, the printed circuit board 62 is positioned in such a way that the top portion of the printed circuit board is further from the back surface 50, and thus closer to the front surface 52 of the housing 44 than the bottom portion of the printed circuit board 62. In some embodiments, because of the curvature of the front surface 52 of the housing 44, camera 18 is located at a position where it would need to be at an angle to be flush to the front surface 52. In these embodiments, the top portion printed circuit board 62 may be substantially parallel to a tangent of the inside of the front surface 52 of the housing 44 at the location of this camera 18 to allow for the mechanical coupling described above.

According to embodiments where the camera 18 is angled with respect to the central horizontal axis 78 (i.e., not parallel to the central horizontal axis 78), and as illustrated in FIG. 6B, the vertical field of vision 48 is shifted so that a greater area beneath the central horizontal axis 78 is exposed to the camera 18. This more significant area of exposure beneath the central horizontal axis 78 may allow the user to see more of the ground beneath the doorbell system 10, which may facilitate the user's ability to see items such as packages that have been delivered.

According to some embodiments, the vertical field of vision 48 is between 140 and 160 degrees. However, different embodiments could see this vertical field of vision 48 reduced to only 90 degrees or expanded to 180 degrees, depending on the user's needs. The horizontal field of vision, while not illustrated, may display similar characteristics.

According to some embodiments, the tapered profile 42 of the top surface 54 is rounded and defines a radius of 125 mm, as illustrated in FIG. 6A. In some embodiments, such as those shown in FIG. 6B, the tapered profile 42 of the top surface 54 may define a radius of 75 mm. The radius of the tapered profile 42 of the top surface may be whatever is desired and does not need to be rounded.

According to some embodiments, such as those illustrated by FIGS. 6A and 6B, the tapered profile 42 of the bottom surface 56 is rounded and defines a radius of 200 mm. Similar to the tapered profile 42 of the top surface 54, the radius of the tapered profile 42 of the bottom surface may be whatever is desired and does not need to be rounded.

In some embodiments, the printed circuit board 62 defines a footprint, including a width of 30 mm and a height of 72 mm. The printed circuit board 62 may lie at an angle of 7 degrees with respect to the central vertical axis 80. While this footprint and angle of bias are disclosed herein, they are exemplary only, and any combination of footprint and angle of bias that fits within housing 44 may be used.

FIG. 7 illustrates a doorbell 12 communicatively coupled to a remote computing device 38, such as a smartphone, tablet, laptop computer, desktop computer, wearable device, and the like. In some embodiments, the remote computing device 38 allows a user to activate the light 24 located within the doorbell 12 to project the illumination 26 onto the surface 28. In some embodiments, the light 24 may be activated by any such trigger described above and including, but not limited to: waking up the remote computing device 38, activating the software application 40, a predetermined time of day occurring, a predetermined event occurring, and the like. It should be appreciated that any function performed on or by the remote computing device 38 or anything detected by the doorbell 12 may trigger the doorbell 12 to project the illumination 26 from the light 24 onto the surface 28.

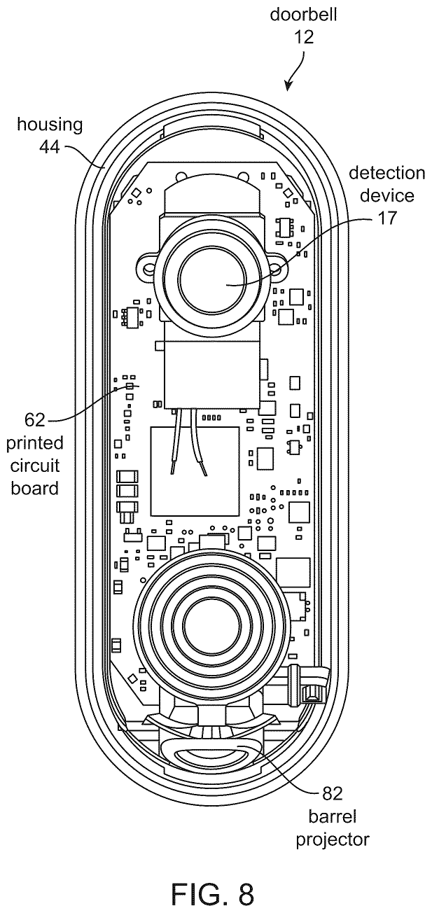

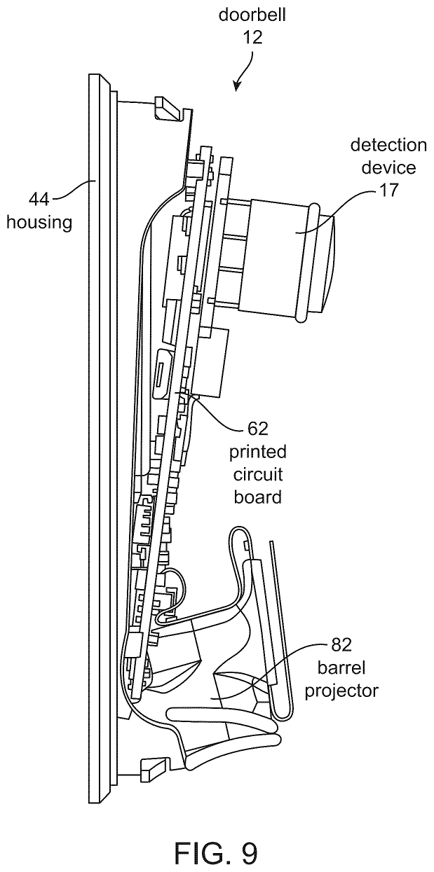

FIG. 8 illustrates a front view of a doorbell 12 with a portion of the housing 44 removed, and FIG. 9 illustrates a side view thereof. Specifically, in each of FIGS. 8 and 9, the front section of the housing 44 is removed, permitting a view of the printed circuit board 62. While not strictly necessary with respect to locations, a detection device 17 can be seen near the top of the printed circuit board 62, and a barrel projector 82 can be seen near the bottom of the printed circuit board 62.

In FIG. 9, the angle of the printed circuit board 62 may be seen. As described above in FIG. 6B, the angle of the printed circuit board may increase the field of view of the detection device 17 with respect to the ground, thus permitting the detection device 17 to see objects that may lay on the ground, such as packages.

The barrel projector 82 may also be seen angled in an opposing direction to the printed circuit board 62. This angle of the barrel projector 82 may permit messages or images projected from the barrel projector 82 to be more readily visible to a person approaching the doorbell 12, as it may permit the messages or images to be projected further away from the building to which the doorbell 12 is attached.

Some of the components listed herein use the same number from figure to figure. It should be appreciated these components use the same numbers solely for ease of reference and to facilitate comprehension for the reader. While these components may use the same numbers, differences may be present in these components as illustrated in the various figures in which they appear and as described in the specification herein.

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

The foregoing may be accomplished through software code running in one or more processors on a communication device in conjunction with a processor in a server running complementary software code.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

It is appreciated that in order to practice the method of the foregoing as described above, it is not necessary that the processors and/or the memories of the processing machine be physically located in the same geographical place. That is, each of the processors and the memory (or memories) used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the foregoing, be performed by a single component. Further, the processing performed by one distinct component as described above may be performed by two distinct components. In a similar manner, the memory storage performed by two distinct memory portions, as described above, may, in accordance with a further embodiment of the foregoing, be performed by a single memory portion. Further, the memory storage, performed by one distinct memory portion, as described above, may be performed by two memory portions.

Further, various technologies may be used to provide communication between the various processors and/or memories, as well as to allow the processors and/or the memories of the foregoing to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the foregoing. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software may instruct the processing machine what to do with the data being processed.

Further, it is appreciated that the instructions or set of instructions used in the implementation and operation of the foregoing may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the foregoing. Illustratively, the programming language used may include assembly language, Ada, APL, Basic, C, C++, COBOL, dBase, Forth, Fortran, Java, Modula-2, Pascal, Prolog, Python, REXX, Visual Basic, and/or JavaScript, for example. Further, it is not necessary that a single type of instruction or single programming language be utilized in conjunction with the operation of the system and method of the foregoing. Rather, any number of different programming languages may be utilized as is necessary and/or desirable.

Also, the instructions and/or data used in the practice of the foregoing may utilize any compression or encryption technique or algorithm, as may be desired. An encryption module might be used to encrypt data. Further, files or other data may be decrypted using a suitable decryption module, for example.

As described above, the foregoing may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the foregoing may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the foregoing.

Further, the memory or memories used in the processing machine that implements the foregoing may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the foregoing, a variety of “user interfaces” may be utilized to allow a user to interface with the processing machine or machines that are used to implement the foregoing. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the foregoing, it is not necessary that a human user actually interact with a user interface used by the processing machine of the foregoing. Rather, it is also contemplated that the user interface of the foregoing might interact, i.e., convey and receive information, with another processing machine, rather than a human user. Accordingly, the other processing machine might be characterized as a user. Further, it is contemplated that a user interface utilized in the system and method of the foregoing may interact partially with another processing machine or processing machines, while also interacting partially with a human user.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

We claim:

1. A doorbell system, comprising:
a housing having a flat back surface and a curved front surface facing opposite the flat back surface; and
a doorbell coupled to the housing, the doorbell including a visitor detection system comprising a detection device selected from the group consisting of a camera, a microphone, and a motion detector.

2. The doorbell system of claim 1, wherein the curved front surface defines a concave curvature.

3. The doorbell system of claim 2, wherein a degree of curvature of the curved front surface is substantially symmetrical about a central horizontal axis of the housing.

4. The doorbell system of claim 1, wherein the housing defines a substantially ovular circumferential profile.

5. The doorbell system of claim 1, wherein the housing includes a first surface and a second surface opposite the first surface, and wherein the first surface and the second surface are substantially parallel for at least a portion of a length of the doorbell.

6. The doorbell system of claim 1, wherein the housing includes a top surface and a bottom surface located opposite the top surface, wherein at least a portion of the top surface and at least a portion of the bottom surface comprise tapered profiles.

7. The doorbell system of claim 6, wherein the tapered profile of the top surface tapers downward from the flat back surface toward the curved front surface, and
wherein the tapered profile of the bottom surface tapers upward from the flat back surface toward the curved front surface.

8. The doorbell system of claim 1, further comprising a software application running on a remote computing device communicatively coupled to the doorbell.

9. The doorbell system of claim 1, wherein the camera is located above a central horizontal axis of the housing and is pointing at least partially downward toward a bottom side of the doorbell, the camera defining a vertical field of vision between 140 degrees and 160 degrees.

10. The doorbell system of claim 9, wherein the camera further comprises a retinal scanner for identifying a visitor.

11. The doorbell system of claim 9, further comprising a printed circuit board coupled to the housing, the printed circuit board electronically and mechanically coupled to the camera, wherein the printed circuit board is arranged and configured to at least partially align with a curvature of the housing.

12. The doorbell system of claim 11, the housing further comprising a camera aperture and a camera surface adjacent to the camera aperture, the camera aperture configured to provide a viewing window for the camera, wherein the printed circuit board is substantially parallel to the camera surface.

13. The doorbell system of claim 1, further comprising a projection light coupled to a bottom surface of the housing, wherein the projection light is configured to project an illumination on a surface.

14. The doorbell system of claim 13, wherein the projection light is configured to constantly project the illumination.

15. The doorbell system of claim 13, wherein the projection light is aimed away from a central horizontal axis and the projection light is aimed along a central vertical axis.

16. The doorbell system of claim 13, wherein the projection light is coupled to a tapered portion of the bottom surface of the housing, such that the projection light is aimed away from both a central horizontal axis and a central vertical axis.

17. The doorbell system of claim 13, wherein the projection light is configured to project the illumination in response to a press of a button.

18. The doorbell system of claim 13, wherein the projection light is configured to project the illumination in response to an indication of a presence of a visitor by a camera.

19. The doorbell system of claim 1, wherein the visitor detection system further comprises a speaker located adjacent a top surface of the housing.

20. The doorbell system of claim 19, wherein a curvature of the curved front surface is arranged and configured to enhance a sound quality from the speaker, and wherein the sound quality comprises a treble component and a bass component.
